(19) United States
(12) Patent Application Publication
(10) Pub. No.: US 2014/0046027 A1
(43) Pub. Date: Feb. 13, 2014

(54) Double Click Technology

(71) Applicants: Janne Laine, Aalto (FI); Sami Nummelin, Aalto (FI); Eero Kontturi, Aalto (FI); Olli Ikkala, Aalto (FI); Ilari Filpponen, Aalto (FI); Henna Rosilo, Aalto (FI)

(72) Inventors: Janne Laine, Aalto (FI); Sami Nummelin, Aalto (FI); Eero Kontturi, Aalto (FI); Olli Ikkala, Aalto (FI); Ilari Filpponen, Aalto (FI); Henna Rosilo, Aalto (FI)

(73) Assignee: AALTO UNIVERSITY FOUNDATION, Aalto (FI)

(21) Appl. No.: 14/003,656

(22) PCT Filed: Mar. 7, 2012
(86) PCT No.: PCT/FI2012/050224

§ 371 Date: Oct. 15, 2013

(30) Foreign Application Priority Data
Mar. 7, 2011 (FI) 20115227

(51) Int. Cl. C08B 15/06

(52) U.S. Cl. CPC C08B 15/06
USPC 530/363; 530/362; 530/385; 530/395; 536/23.1; 536/30

(57) ABSTRACT

The present invention concerns a method of modifying the surface of a cellulosic material, wherein a modifying compound is attached to the cellulosic material through a linker, which linker is a conjugate that has been activated by functionalization prior to adsorption to form an activated conjugate, and wherein the entire method is carried out in aqueous media, as well as an intermediate product suitable for attaching to a modifying compound, the intermediate product comprising said functionalized conjugate linker that has been adsorbed to a cellulosic material.

### FIELD OF THE INVENTION

The present invention concerns a method of modifying the surface of a cellulosic material, as well as an intermediate product of said method.

### DESCRIPTION OF RELATED ART

Cellulose is the Earth's most abundant renewable organic raw material for the production of novel biomaterials. The development of versatile techniques for the cellulose modification is necessary for increasing the reactivity and compatibility of cellulose with other materials. In general, 1,3-dipolar cycloaddition reactions have long been popular in the generation of carbohydrate mimetics in homogeneous reaction environment (Gallos, J. K. et al., 2003). More precisely, the thermally induced cycloaddition (Huisgen reaction) occurs between an azide and a triple bond and is nowadays often referred as a member of the click reaction family because of its robustness (Scheme 1) (Huisgen, R. et al, 1960).

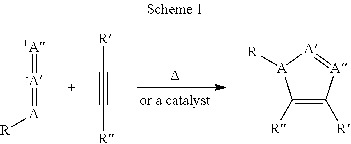

The Huisgen Cycloaddition is the reaction of a dipolarophile with a 1,3-dipolar compound that leads to 5-membered (hetero)cycles. The reaction has gained increasing attention after discovering that the 1,3-dipolar cycloaddition between azides and terminal alkynes can be catalysed by Cu(I) salts (Copper(I)-catalyzed Azide-Alkyne Cycloaddition (CuAAC)) (Toraoe, C. W. et al., 2002; Rostovtsev, V. V. et al., 2002; Lewis, W. G. et al, 2002; Lewis, W. G. et al, 2002; Kolb, H. C. et al, 2001; and Iha, R. K. et al, 2009). In fact, the Copper(I)-catalyzed Azide-Alkyne Cycloaddition (CuAAC) has become the most popular click reaction to date by the virtue of its high yields, rapidity, high regio- and stereoselectivity, mild reaction conditions and experimental simplicity. Several authors have described the use of this click chemistry concept for the generation of carbohydrate mimetics and derivatives (Huisgen, R., 1989; Kolb, H. C. et al, 2001; Wu, P. et al, 2004; and Gupta, N. et al, 2006). In addition to said Huisgen cycloadditive click reactions, there are also other chemical reactions that are robust and quick, and may allow similar versatile chemical platform for molecular tailoring, and are here included in the click chemistry concept. Examples of such reactions comprise e.g. free-radical addition of alkyl iodides onto double bonds, mercaptans onto double or triple bonds, where the latter reaction has even been denoted as “thiol-click” reaction and nucleophilic thio-bromo click reaction, specifically base-mediated thioetherification of thioglycerol with α-bromoesters (see e.g. Justynska, J. et al. 2005 Killops, K. L. et al. 2008; thiol-ene, Rosen, B. R. et al. 2009 thio-bromo). All above mentioned reactions are later denoted simply as “click reactions”.

Due to the chemical functionality of polysaccharides (bearing hydroxyl, carboxylic acid and amine groups) esterification, etherification and amidation are the most common approaches for the modification reactions of polysaccharides. However, these modification reactions often need organic solvents and/or rather harsh reaction conditions to be sufficient enough. Therefore, new methods for biomaterial functionalizations are nowadays heavily explored. Click-chemistry is one of the most promising approaches up to date and an increasing amount of research efforts are conducted for the click chemistry based modifications of bio materials.

The use of click chemistry is known on a general level, for example from WO2010099818 A1, which discloses a composition for manufacturing a hydrogel in an aqueous solution. In this composition, a polymer or a bioactive compound has been attached to the surface of a hydrophilic polysaccharide using click chemistry. Similarly, in WO2008031525 A1, a method for manufacturing polycarboxylated polysaccharides, such as derivatives of carboxymethyl cellulose (CMC), has been described, in which method the derivative has been attached using click chemistry.

The surface functionalization of cellulose, on the other hand, is known on a general level, for example from WO 0121890 A1, wherein the modification of cellulose fibres using CMC or a derivative thereof in an aqueous solution is described.

Directly attaching the desired modifying molecule to a substrate has the disadvantage of the reaction requiring both components to have suitable and matching charges. Thus, when carrying out the reaction in an aqueous solution, only hydrophilic compounds can be used. This causes quite some limitations to the method.

### SUMMARY OF THE INVENTION

The fact that certain polysaccharides have an affinity to adsorb onto a cellulosic surface allows for performing a physicochemical conversion of the cellulosic material into valuable materials by using the adsorption of activated polysaccharides combined with click chemistry reactions.

Accordingly, the overarching goal of the present invention is to provide a novel environmentally friendly technique for the modification of cellulosic materials in aqueous media.

More specifically, it is an object of the present invention to provide a novel method for the modification of cellulosic materials providing a higher variation in the resulting properties of the modified material compared to the prior art methods.

These and other objects, together with the advantages thereof over known methods and resulting materials, are achieved by the present invention, as hereinafter described and claimed.

The proposed novel technique will provide a route for the homo- and heterogeneous conversion of cellulosic sources into valuable materials via an adsorption of activated conjugates onto the source. The new reactive sites introduced on the cellulosic surface provide a pathway and an intermediate product for the further tailor-made modifications of cellulose by means of the click chemistry reactions.

The present invention concerns a method of modifying the surface of a cellulosic material, wherein a modifying compound is attached to the cellulosic material through a linker or a spacer.

More specifically, the method of the present invention is characterized by what is stated in the characterizing part of Claim 1.

Further, the intermediate product of the present invention is characterized by what is stated in the characterizing part of Claim 11.

The basis of the invention is the functionalization of the surface of the cellulosic material in an aqueous solution.

It has been previously demonstrated that carboxymethyl cellulose (CMC) adsorbs irreversibly on cellulose (Laine, J. et al, 2000). Now it has surprisingly been found that installing specific chemical groups onto the surface of the cellulosic material (e.g. filter paper, nanofibrillated cellulose (NFC)) to alter its physicochemical properties can be accomplished to give a higher variation in possible modifications without increasing the required variation in reaction conditions.

In principle, the processing technology can be used with a variety of cellulosic linkers, e.g. conjugates, CMC, hemicelluloses and polysaccharides such as glucomannan, xyloglucan and chitosan.

Considerable advantages are obtained by means of the invention. Thus, the present invention provides a novel method for the modification of cellulosic material resulting in a higher variation in the properties of the obtained modified material compared to the prior art methods.

The click reactions utilized in the invention deal effective, regioselective, rapid and high yield chemical reactions that can be carried out in a thermodynamic manner, and comprise cycloadditions.

Other features and advantages of the process are that:
the adsorption phenomena of the conjugate allows for heterogeneous modifications of the cellulosic materials,
the click chemistry provides multiple ways for the modification of cellulosics with desired functionalities and properties, such as charge, fluorescence, antimicrobial properties, hydrophobicity, cross-linking, solubility, processability, surface energy, electronic and magnetic properties (+para/superpara), conducting properties, optical properties, and superhydropobic properties,
the use of organic solvents can be completely avoided, and the modifications are carried out in aqueous media, thereby providing an industrially attractive method, and
the raw materials may be obtained from biorefineries, and are completely renewable materials.

Next, the invention will be described more closely with reference to the attached drawings and a detailed description.

### BRIEF DESCRIPTION OF THE DRAWINGS

FIG. 1 is an FTIR spectrum of azide-derivatized CMC (solid line) and control CMC (dashed line).

FIG. 2 is an FTIR spectrum of alkyne-derivatized CMC (solid line) and control CMC (dashed line).

FIG. 3 shows QCM curves of azide-derivatized CMC, alkyne-derivatized CMC and control CMC.

FIG. 4 shows QCM curves of azide-derivatized CMC with alkyne-derivatized BSA and without copper (I) (CMC-azido/BSA-alkyne, control), azide-derivatized CMC with copper (I) (CMC-azido/Cu(I)/Ascorbic acid, control) and azide-derivatized CMC with alkyne-derivatized BSA and copper (I) (CMC-azido/BSA-alkyne/Cu(I)/Ascorbic acid, click reaction).

FIG. 5 shows AFM images of a) azide-derivatized CMC with alkyne-derivatized BSA and copper (I) (click reaction), b) azide-derivatized CMC with alkyne-derivatized BSA and without copper (I) (control) and c) azide-derivatized CMC with copper (I) (control).

FIG. 6 shows QCM curves of propargyl-derivatized CMC with OMe-PEG-N₃ and without copper (I) (CMC-propargyl/OMe-PEG-N₃, control) and propargyl-derivatized CMC with OMe-PEG-N₃ and copper (I) (CMC-propargyl/OMe-PEG-N₃/Cu(I), click reaction).

### DETAILED DESCRIPTION OF THE PREFERRED EMBODIMENTS OF THE INVENTION

The present invention concerns a method of modifying the surface of a cellulosic material, wherein a modifying compound is attached to the cellulosic material through a linker, which linker is a conjugate that has been activated by functionalization prior to adsorption to form an activated conjugate, and wherein the entire method is carried out in aqueous media. The compounds and materials used in the method may vary widely, within the ranges disclosed below.

The cellulosic material may be based on cellulose fibre, fines, nano or micro cellulose fibrils, microcrystalline cellulose, nanocrystalline cellulose (nanowhisker) or some other cellulose based material, including different regenerated cellulose materials such as textile fibres as well as paper and board grades, such as filter papers.

The modifying compound may be in the form of biomolecules, such as DNA, RNA, albumin, including bovine serum albumin (BSA), biotin, hemoglobin, and other proteins, polymers, low molecular weight polymers, ranging to oligomers, dyes, including luminescent dyes, radio labels, and nanoparticles, or mixtures or complexes thereof.

The method utilizes so-called click chemistry reactions, for example in the activating functionalization reactions, which term (click reactions) is intended to include a group of selective, rapid and high yield chemical reactions that can be carried out in a thermodynamic manner, comprising cycloaddition reactions, such as Diels-Alder reactions, Huisgen reactions, Copper(I)-catalyzed Azide-Alkyne Cycloaddition (CuAAC) and other 1,3-dipolar cycloaddition reactions, as well as reactions of mercaptans to double or triple bonds (“thiol” click), halogens to double bonds, and, to the extent that they give a stable product, also ionic reactions.

Particularly, the activating functionalization reaction is selected from reactions that provide the conjugate with a functionality selected from azide, triple bond, double bond, thiol, and halogen.

Copper(I)-catalyzed Azide-Alkyne Cycloaddition (CuAAC) reactions are of particular importance for the present invention, as they are rapid and high-yield condensation reactions between azide groups and terminal triple bonds, which have been found particularly useful in the present invention. The other features of the azide-containing compound and the alkyne, such as stereochemistry and the presence of other functionalities, are not particularly limited.

The “conjugates” suitable for use in the present invention are at least bifunctional compounds selected from, among others, various cellulose derivatives, such as carboxymethyl cellulose (CMC) and polysaccharides, such as glucomannan, xyloglucan, chitosan and different gums.

The functionalization of the conjugate, to activate it, is carried out via reactions that attach an activating part to the conjugate to form a suitable starting material for click-reactions. The activating part may vary widely and is preferably a non-aromatic organic compound having a C2-C30 hydrocarbon chain (or oligomer or polymer chain), optionally containing heteroatoms selected from O, N and S. These functionalization reactions are preferably esterifications, etherifications, amidations, epoxidations or urethane formations that take place on the carbonyl or hydroxyl groups of the conjugate molecule, whereby the activating part may most suitably be an amine, a carboxylic acid, an alcohol, an epoxide or an urethane. The functionalization reactions are most preferably amidations utilizing e.g. EDC (1-ethyl-3-[3-dimethylaminopropyl]carbodiimide hydrochloride) and NHS (N-hydroxysuccinimide).

Thus, the final conjugation sites of the conjugate, that attach to the functional groups on the modifying molecule, are the active sites introduced via the activating parts or molecules.

Similar functionalizations are preferably carried out also on the modifying compound, thereby providing matching conjugations sites for a click reaction on both the conjugate and the modifying molecule. Most suitably, the conjugate and the modifying compound are subjected to different functionalization reactions, thereby providing one of these components with an azide, a thiol or a halogen functionality and the other component with a triple bond or a double bond functionality.

According to an embodiment of the present invention, the method of the invention includes three steps (shown in Scheme 2). In step 1, a click activation part is attached to the conjugate. In step 2, the conjugate is adsorbed to the cellulosic material. In step 3, the desired modifying compound is attached to the click activation part now present on the cellulosic surface.

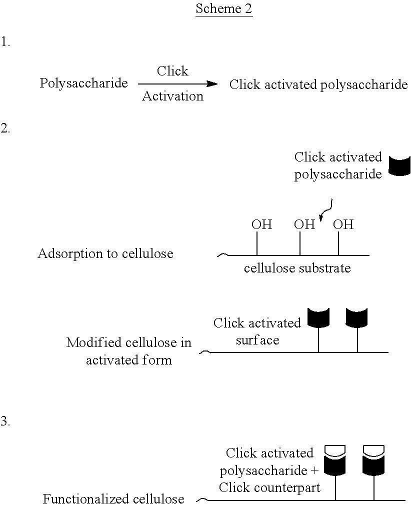 [SMILES: O ; O ; O]

According to another embodiment of the invention, steps 2 and 3 are reversed compared to the above.

The method is preferably implemented via carbodiimide-mediated formation of an amide linkage between the carboxyl-bearing bio-substrates and the precursors carrying a terminal amine functionality. These grafted amine compounds should contain terminal alkyne or azide functionalities that are necessary for the click-chemistry reaction. Finally, the alkyne and azide functionalized biomaterials can be ‘clicked’ with, i.e. adsorbed to, a large number of compounds in order to produce the final materials with the desired properties. It is important to note here that these reactions can be carried out in heterogeneous aqueous environment and they can be rather easily applied with all the biomaterials carrying carboxylic acid functionality and having an affinity to cellulose such as proteins, polysaccharides, pectins and hemicelluloses.

Also multifunctionalization is possible, whereby more than one different type of conjugate is activated and attached to the cellulosic surface.

According to a preferred embodiment of the invention, the adsorption of the linker to the surface of the cellulosic material takes place through multiple interactions, mainly through the hydroxyl, carbonyl, amine or sulphate groups present on the surfaces of both the linker and the cellulosic material.

Since certain polysaccharides co-crystallize with cellulose, the final structure may become a permanent part of the surface.

The adsorption reactions can be based on physical interactions, such as adsorption or entrapment, including electrostatic interactions, van der Waals forces, π-π interactions and hydrogen bonds (i.e. non-covalent), or on covalent attachment. The conjugate is most likely adsorbed to the cellulosic surface via several hydrogen bonds, while the other adsorptions preferably are based on covalent binding.

According to a preferred embodiment of the present invention, an intermediate product is first prepared, and optionally stored or transported to the location of its use, whereafter a modifying compound is adsorbed to it.

According to this embodiment, the intermediate product comprises a functionalized conjugate linker that has been adsorbed to a cellulosic material. The conjugate and its functionalization are preferably the ones described above. Most suitably, the intermediate product consists of said functionalized conjugate linker adsorbed to a cellulosic material.

The final product of the method of the present invention is a cellulose-based product having a surface that has been modified by the adsorption of one or more layers of a modifying compound, and includes biointerfaces, bioactive paper and textile products, electroactive and electrically conducting compositions, hydrophobic and superhydrophobic materials, optically active materials, porous materials, and materials and intermediate products for high strength composite materials, particularly thermo/stimuli responsive materials, branched materials, dendritic materials, graphene, SWCNT, MWCNT, nanoclay, fluorescent materials, and supramolecular materials. When more than one layer of the modifying compound is adsorbed, the further layers are generally adsorbed mainly via physical interactions, although a covalent activation of the modifying compound of the primary layer could be used to attach also the further layers covalently.

The following examples illustrate the function of some preferred embodiments of the invention, and are not to be construed as limitations of the invention.

### EXAMPLES

FTIR, QCM, AFM, elemental analysis and XPS were used to characterize the main chemical, swelling and morphological features of the produced, novel platforms based on the associated, derivatized cellulosic materials.

### Materials:

Bovine serum albumin (#29130), NHS (N-hydroxysuccinimide, #24500), EDC (1-ethyl-3-[3-dimethylaminopropyl]carbodiimide hydrochloride, #22980) were purchased from Pierce (Rockford, Ill., USA). Ethanolamine (Ethanolamine, #398136), CMC (carboxymethyl cellulose, Mw 250 000, DS−0.7, #419311) and methoxypolyethylene glycol azide (OMe-PEG-N₃, Mw 20,000 gmol⁻¹) were obtained from Sigma-Aldrich (Helsinki, Finland). The water used in all solutions was deionized and further purified with a Millipore Synergy UV unit. The QCM-D crystals were AT-cut quartz crystals supplied by Q-Sense AB (Västra Frölunda, Sweden). The fundamental frequency (f₀) was 5 MHz and the sensitivity constant (C) was 17.7 ngHz⁻¹cm⁻². Carboxymethyl cellulose (CMC, 0.5 g/l) was dissolved in 25 mM CaCl₂ at pH 6. The EDC/NHS conjugation solution was prepared dissolving 0.125M EDC and 0.125M NHS in NaAc-buffer solution (10 mM, pH 5, fixed conductivity 3 mS/cm). Ethanolamine was dissolved in MilliQ-water at a concentration 0.2 M and pH was adjusted to 8.5 by adding HCl. BSA was dissolved in PBS-buffer (pH 7.2) at a concentration of 100 μg/ml. CuSO₄×5H₂O/Ascorbic acid solution was prepared by dissolving 40 mg of CuSO₄×5H₂O and 140.9 mg of ascorbic acid in 50 mL of PBS-buffer.

### Example 1

### Preparation of Cellulose Model Films

Substrates for the spincoated cellulose model film preparation were silicon dioxide (SiO₂) covered QCM-D sensor crystals. Trimethylsilylcellulose (TMSC) was diluted in toluene and then spin coated with a spinning speed of 4000 revolutions per minute (RPM) (Kontturi, E. et al, 2003). Prior to use in QCM-D, deposited TMSC layer on the SiO₂ crystals was converted to cellulose by desilylation with the hydrochloric acid vapor according to a previously published method (Schaub, M. et al, 1993).

### Example 2

### Synthesis of Azide-Modified CMC

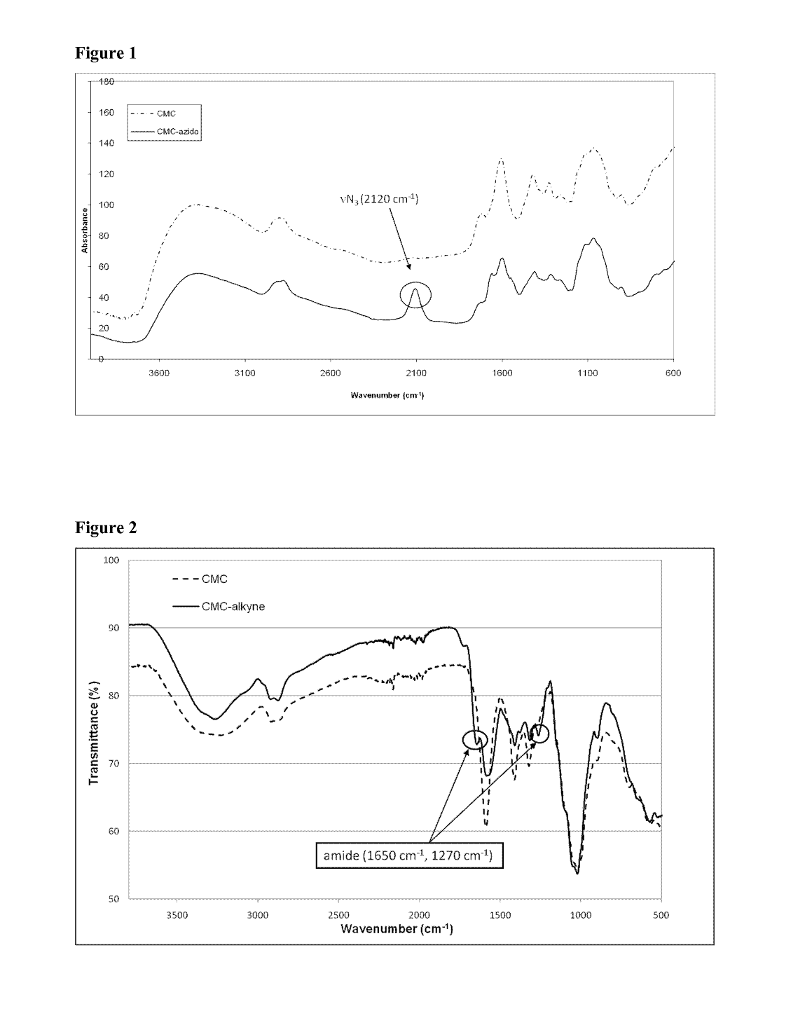

A 50 mg amount of CMC (DS=0.7, M_{w}=25 kDa) was dissolved in 40 mL of NaAc-buffer solution (10 mM, pH 5, fixed conductivity 3 mS/cm). In typical synthesis, 120 mg of EDC.HCl [N-(3-dimethylaminopropyl)-N′-ethylcarbodiimide hydrochloride)] dissolved in 2.5 mL of NaAc-buffer solution, 72 mg of NHS (A/-hydroxysuccinimide) dissolved in 2.5 mL of NaAc-buffer solution and 100 μL of 11-azido-3,6,9-trioxaundecan-1-amine, respectively, were added to the CMC mixture. We emphasize that the selection of 11-azido-3,6,9-trioxaundecan-1-amine is not critical and the composition may vary widely, with successful reactions being achieved with different lengths of the oxyethylene linking chain between the azido and amine groups, selection of different linking chains or spacers and selection of the amine end group, depending on the selected chemical reactions. The reaction was performed at room temperature under stirring for 24 h followed by the addition of ethanolamine (0.2M, 61 mg dissolved in 5 mL of MilliQ FLH₂O). The resulting mixture was dialyzed (MWCO=12 kDa) against distilled water for 3 days. Finally, the solutions were dried using a lyophilizing system to recover the azido-modified CMC (see Scheme 3). FTIR of modified CMC reveals a new stretching band at 2120 cm⁻¹ characteristic for azides and a stretching band at 1650 cm⁻¹ characteristic for amides (FIG. 1). Elemental analysis confirmed the successful grafting reactions, i.e., the elevated amount of nitrogen (amide bond) in modified CMC (Table 1).

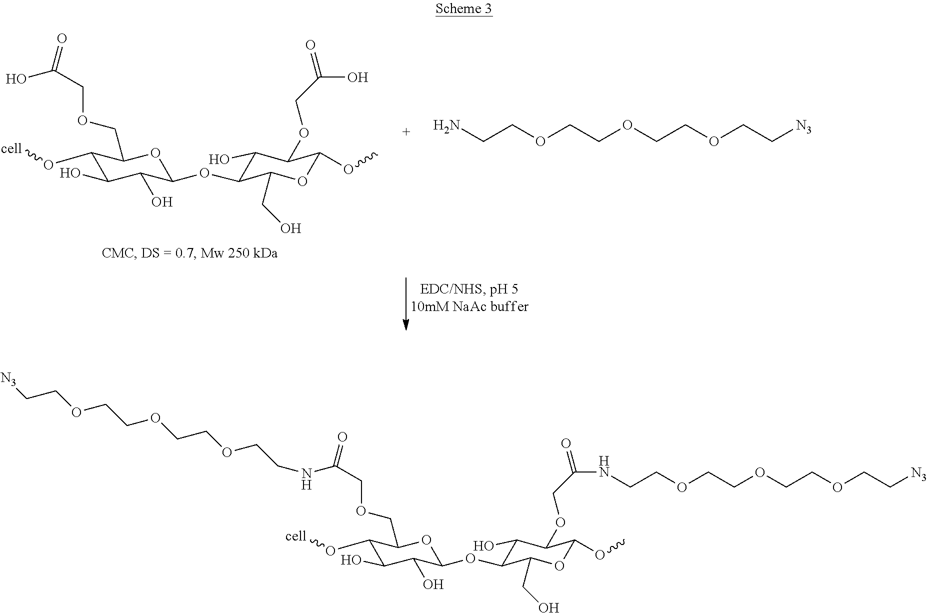

### Example 3

### Synthesis of Alkyne-Modified CMC

A 50 mg amount of CMC (DS=0.7, M_{w}=25 kDa) was dissolved in 40 mL of NaAc-buffer solution (10 mM, pH 5, fixed conductivity 3 mS/cm). In typical synthesis, 120 mg of EDC.HCl [N-(3-dimethylaminopropyl)-N′-ethylcarbodiimide hydrochloride)] dissolved in 2.5 mL of NaAc-buffer solution, 72 mg of NHS (N-hydroxysuccinimide) dissolved in 2.5 mL of NaAc-buffer solution and 30 μL of propargylamine, respectively, were added to the CMC mixture. The reaction was performed at room temperature under stirring for 24 h followed by the addition of ethanolamine (0.2M, 61 mg dissolved in 5 mL of MilliQ H₂O). The resulting mixture was dialyzed (MWCO=12 kDa) against distilled water for 3 days. Finally, the solutions were dried using a lyophilizing system to recover the alkyne-modified CMC (see Scheme 4). FTIR of modified CMC reveals new stretching bands at 1650 and 1270 cm⁻¹ characteristic for amides (FIG. 2). Elemental analysis confirmed the successful grafting reactions, i.e., the elevated amount of nitrogen (amide bond) in modified CMC (Table 1).

TABLE 1
Elemental analysis of CMCs.

| Sample | C | H | N | O |
|---|---|---|---|---|
| CMC | 37.6% | 5.2% | 0.2% | 57.0% |
| CMC-azido | 44.5% | 7.2% | 8.2% | 40.2% |
| CMC-alkyne | 46.0% | 6.9% | 6.5% | 40.7% |

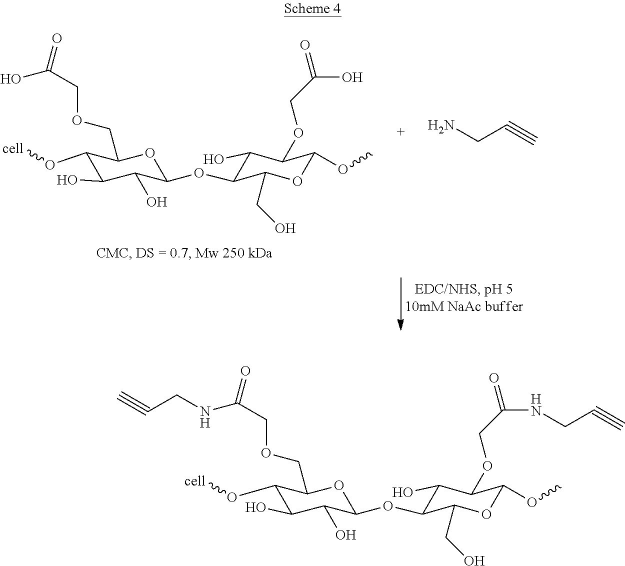

### Example 4

### Synthesis of Alkyne-Modified BSA

N-Alkynyl-Substituted Maleamic Acid. A solution of the appropriate acetylenic amine (0.02 Mol, 1.1 g) in Me₂CO (5 ml) was added dropwise to a refluxing solution of maleic anhydride (0.02 mol, 1.96 g) in Me₂CO (10 ml). The stirred mixture was refluxed for 1 hr and the solvent was then removed. The crystalline residue was purified by recrystallization (Scheme 5, step 1). The residue was purified by recrystallization from MeOH/Et₂O (4:1) mixture affording the title compound as white needles. Yield 1.74 g (57%). TLC (EtOAc) R_{f}=0.44; ¹H-NMR (400 MHz, DMSO-d₆, δ): 13.87 (s, 1H, CO₂H), 9.14 (s, 1H, NH), 6.32 (d, 1H, J=12.3 Hz, CH═CH), 6.26 (d, 1H, J=12.3 Hz, CH═CH), 3.97 (dd, 2H, J=5.5 Hz, J=2.6 Hz, NHCH₂CCH), 3.19 (t, 1H, J=2.6 Hz, CCH); ¹³C-NMR (100 MHz, DMSO-d₆, δ): 166.17 (CONH), 164.60 (CO₂H), 132.01 (CHCO₂H), 130.41 (CHCONH), 79.98 (CH₂CCH), 73.76 (CCH), 28.25 (NHCH₂).

N-Alkynyl-Substituted Maleimide. A mixture of the appropriate N-alkynyl-substituted maleamic acid (3.3 mmol, 0.5 g), Ac₂O (3.75 ml), and anhydrous NaOAc (167 mg) was stirred on a boiling water bath for 1 hr and then cooled. Ice-water (5 ml) was added, and the mixture was stirred for 2 hr. The mixture was neutralized with solid K₂CO₃ under vigorous stirring and then extracted with six 5 ml portions of Et₂O (Scheme 5, step 2). Organic layer was dried over K₂CO₃, filtered and concentrated in vacuo. The residue was purified by column chromatography (siliga gel) using hexane/EtOAc (3:1) as eluent. Evaporation and drying in vacuo gave the title compound as colorless oil which slowly turned into white crystals in the freezer. Yield 0.15 g (34%). TLC (EtOAc) R_{f}0.76; ¹H-NMR (400 MHz, CDCl₃, δ8): 6.75 (s, 2H, CH═CH), 4.27 (d, 2H, J=2.5 Hz, NCH₂C), 2.20 (t, 1H, J=2.5 Hz, CCH); ¹³C-NMR (100 MHz, CDCl₃, δ): 169.21 (C═O), 134.42 (CH═CH), 76.98 (CH₂CCH), 71.50 (CCH), 26.74 (NCH₂).

Alkyne Functionalization of BSA. Without limitations, BSA is selected as a protein showing the versatility to biomolecules. BSA (77.5 mg, 1.17×10⁻³ mmol, 1 equiv.) and N-alkyne functionalised maleimide (10.0 mg, 75.0×10⁻³ mmol, 63 equiv., dissolved in 1 mL methanol) were mixed in PBS (14 mL) at RT. After 24 h, the mixture was centrifuged to remove excess of N-alkyne functionalised maleimide using a 50 mL membrane tube with MWCO 30,000 g/mol. The product (BSA-alkyne) was isolated by lyophilisation (Scheme 5, step 3).

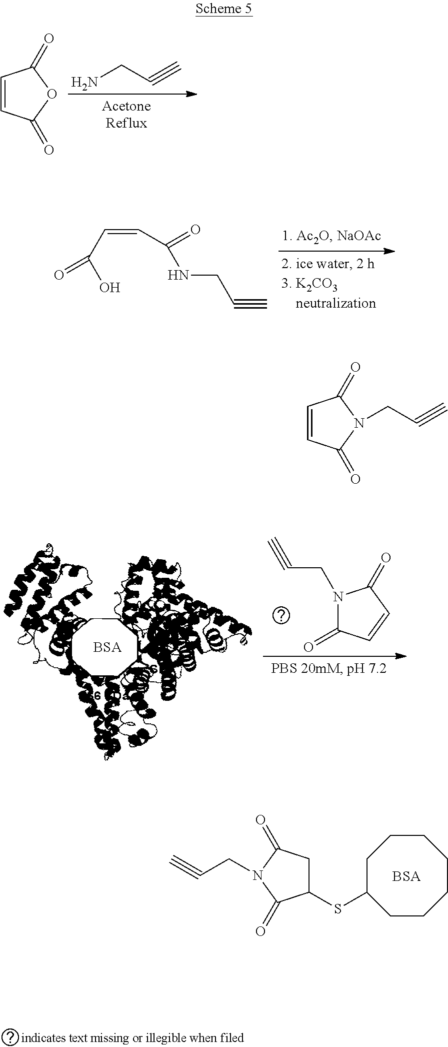

### Example 5

### Analysis

Quartz Crystal Microbalance with Dissipation Monitoring (QCM-D):

The adsorptions of CMC and modified CMCs on cellulose were studied with a QCM-D E4 apparatus from Q-Sense (Västra Frölunda, Sweden). The basic principles of the QCM-D technique has been described by Rodahl et al. (1995) and Höök et al. (1998). The QCM-D measurements were conducted at the fundamental frequency of 5 MHz and its overtones 15, 25, 35, 45, 55 and 75 MHz at 25° C. with the constant flow rate of 0.1 ml/min. The cellulose surfaces were allowed to swell overnight in the appropriate buffer solution in prior to the QCM-D measurements. All the measurements were at least duplicated. Only the changes in the normalized frequencies and dissipations of the fifth overtone have presented to make the illustration simpler.

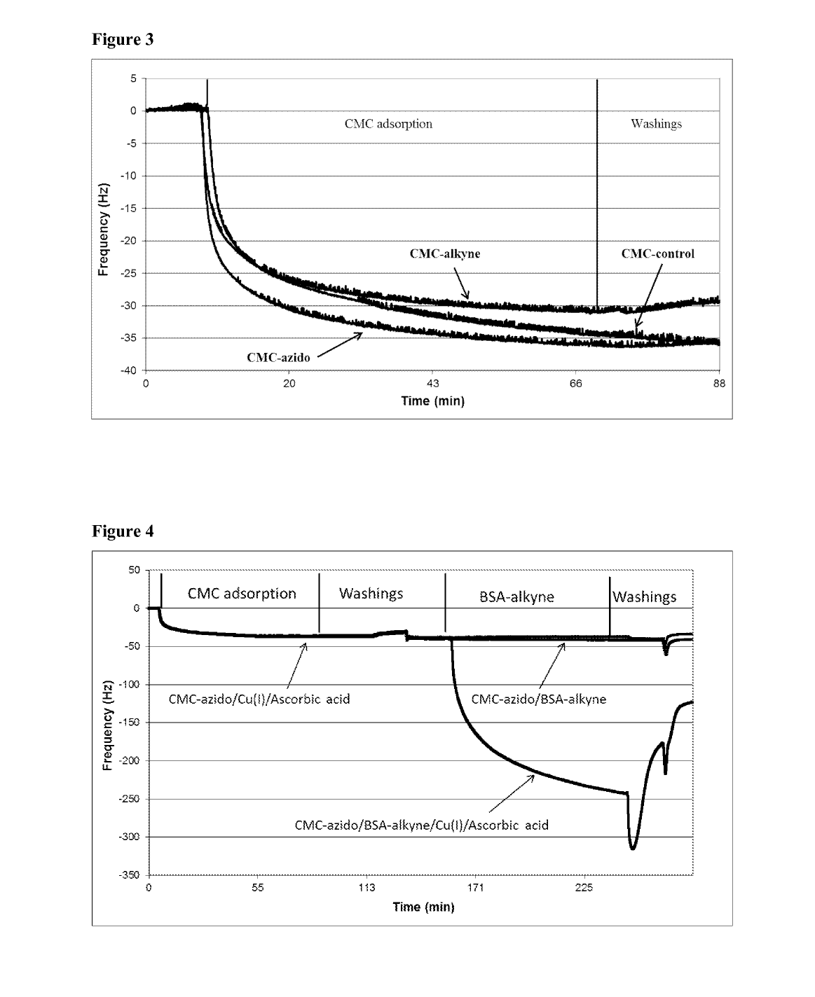

The adsorption of azide-modified CMC is demonstrated in Scheme 6. As can be seen from FIG. 3 both alkyne- and azide-modified CMCs adsorb onto the cellulose model surface. In fact, the adsorption is similar with the adsorption of unmodified CMC.

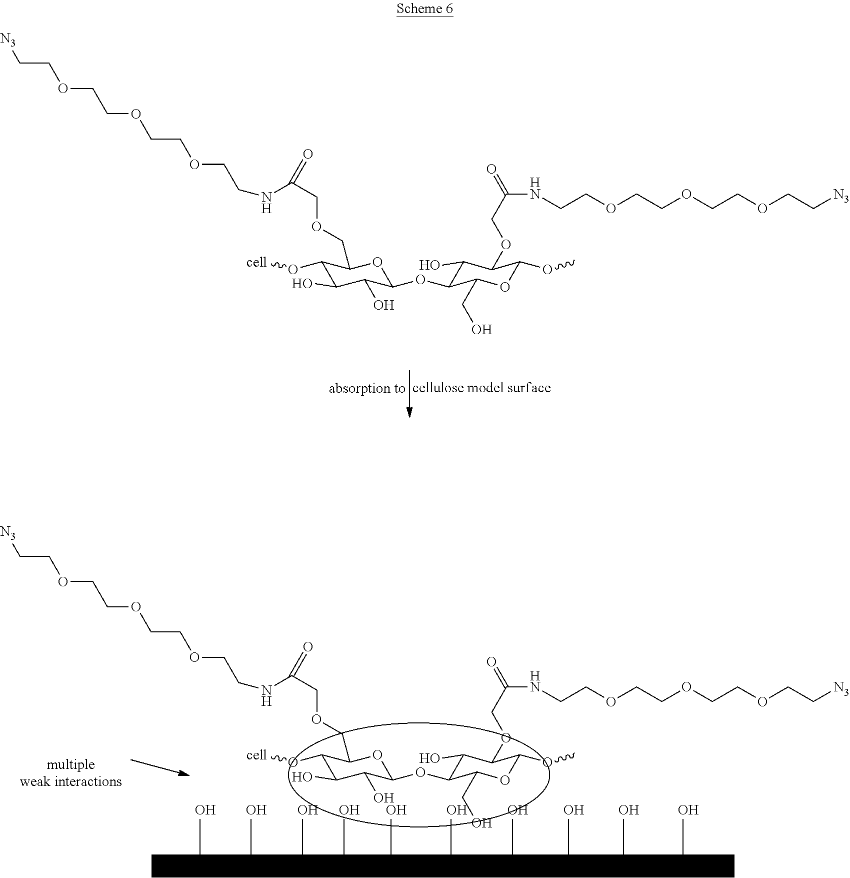

Scheme 7 demonstrates the click reaction between the azide-modified cellulose model surface and alkyne modified BSA. QCM data on FIG. 4 illustrates the click reaction (CMC-azido/BSA-alkyne/Cu(I)/Ascorbic acid). It can be observed that even after extensive washings a significant amount of the BSA remains attached on the cellulose model surface pointing toward covalent linking of BSA. The amount that is washed off most likely represents further layers of BSA that has been only weakly adsorbed to the primary layer. The QCM data of 2 control samples (CMC-azido/BSA-alkyne and CMC-azido/Cu(I)/Ascorbic acid) did not show the binding of the BSA on the cellulose model surface.

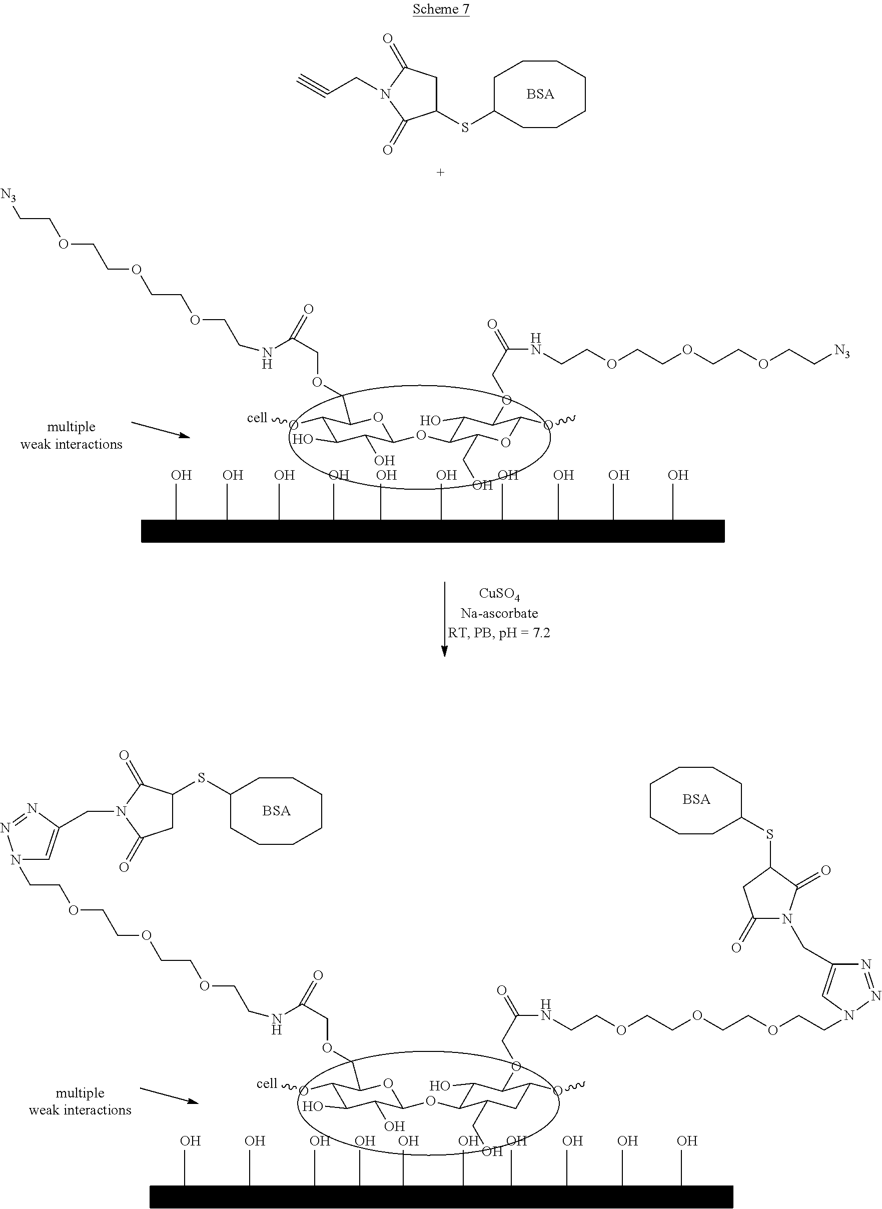

### Atomic Force Microscopy (AFM):

The adsorptions of CMC and modified CMCs on cellulose were also characterized using an AFM instrument; Nanoscope IIIa Multimode scanning probe microscopy from Digital Instruments Inc., Santa Barbara, Calif., USA. The images were scanned using tapping mode in air with silicon cantilevers. The scan sizes of images were 5×5 μm² and 1×1 μm². No image processing except flattening was done and at least three different areas on each sample were measured.

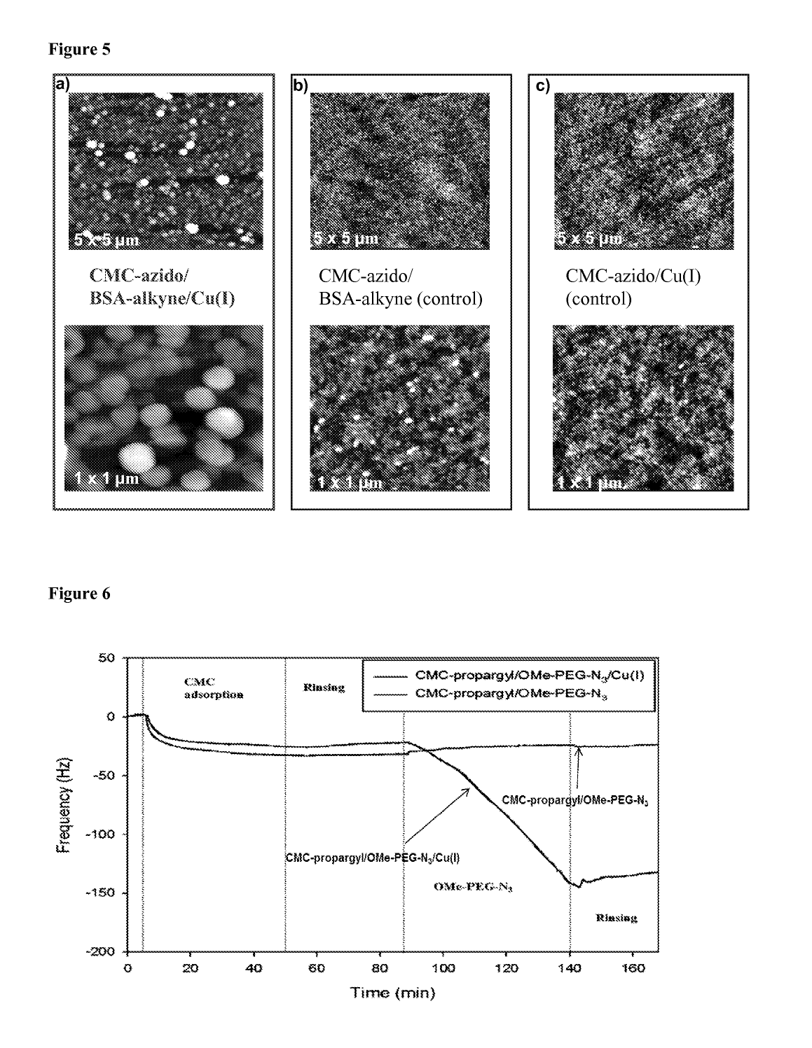

The AFM image (FIG. 5a) clearly shows the patterns of attached BSA on the surface of the cellulose model surface. On the contrary, the AFM images of 2 control samples revealed rather intact cellulose surfaces.

### X-ray Photoelectron Spectroscopy (XPS):

The surface chemical composition of samples was investigated via X-ray photoelectron spectroscopy (XPS). Prior to the experiments the samples were evacuated in pre-chamber overnight and a specified in-situ reference (100% cellulose) was measured with each sample batch, in order to verify satisfactory experimental vacuum conditions during the analysis. The measurements were done using a Kratos Analytical AXIS 165 electron spectrometer and monochromatic Al Kα X-ray irradiation at 100 W. All spectra were collected at an electron take-off angle of 90°. Both elemental wide-region data (1 eV intervals, 80 eV pass energy) and high resolution spectra (0.1 eV intervals, 20 eV pass energy) of carbon (C 1s), nitrogen (N 1s), oxygen (O 1s) and sulfur (S 2p) regions were collected. All spectra were recorded at three different locations on each sample; the area and depth of analysis was 1 mm² and less than 10 nm, respectively. No sample degradation due to ultra-high vacuum or X-rays was observed during the XPS measurements.

XPS data shown in Table 2 clearly demonstrate the elevated amount of nitrogen in BSA-modified cellulose surface.

TABLE 2
XPS data of cellulose surfaces.

| Sample | O 1s | C 1s | N 1s | S 2p | O/C |
|---|---|---|---|---|---|
| CMC-azido/BSA-alkyne/Cu¹ | 22.8 | 64.2 | 12.6 | 0.4 | 0.36 |
| CMC-azido/BSA-alkyne | 42.6 | 56.5 | 0.9 | 0 | 0.75 |
| (control) | | | | | |

Scheme 8 demonstrates the click reaction between the alkyne-modified cellulose model surface and azide-modified methoxy-PEG (Mw 20,000 gmol⁻¹). FIG. 6 illustrates the click reaction (CMC-propargyl/OMe-PEG-N₃/Cu(I)/Ascorbic acid). It can be observed that even after extensive washings a significant amount of the PEG remains attached on the cellulose model surface pointing toward covalent linking of PEG. The QCM data of a control sample (CMC-propargyl/OMe-PEG-Ns) did not show the binding of the PEG on the cellulose model surface.

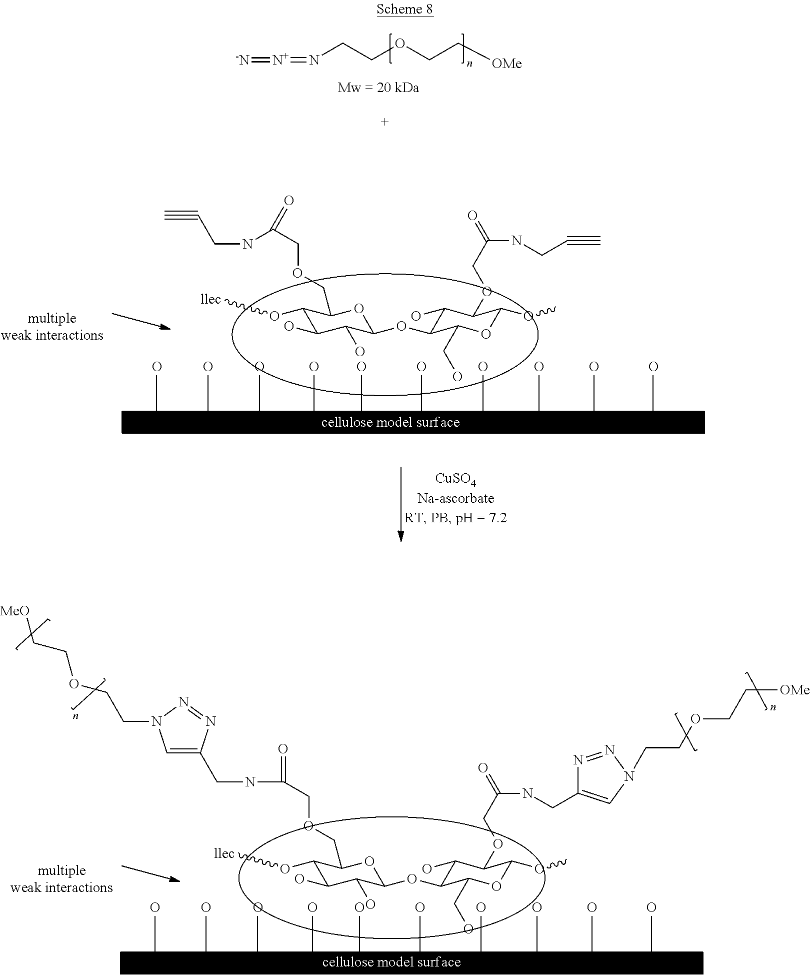

### REFERENCES

1. Gallos, J. K.; Koumbis, A. E. Curr. Org. Chem. 2003, 7, 397-426.
2. Huisgen, R. Proc. Chem. Soc. 1960, 357-369.
3. Tornøe, C. W.; Christensen, C; Meldal, M. J. Org. Chem. 2002, 67, 3057-3064.
4. Rostovtsev, V. V.; Green, L. G.; Fokin V. V.; Sharpless, K. B. Angew. Chem., Int. Ed. 2002, 41, 2596-2599.
5. Lewis, W. G.; Green, L. G.; Grynszpan, F.; Radic, Z.; Carlier, P. R.; Taylor, P.; Finn, M. G.; Sharpless, K. B. Angew. Chem. 2002, 114, 1095-1099.
6. Lewis, W. G.; Green, L. G.; Grynszpan, F.; Radic, Z.; Carlier, P. R.; Taylor, P.; Green, M. G.; Fokin, V. V.; Sharpless, K. B. Angew. Chem., Int. Ed. 2002, 41, 1053-1057.
7. Kolb, H. C; Finn, M. G.; Sharpless, K. B. Angew. Chem. 2001, 113, 2056-2075.
8. Iha, R. K.; Wooley, K. L.; Nyström, A. M.; Burke, D. J.; Kade, M. J.; Hawker, G. J. Chem. Rev. 2009, 109, 5620-5686.
9. Huisgen, R. Pure Appl. Chem. 1989, 61, 613-628.
10. Kolb, H. C; Finn, M. G.; Sharpless, K. B. Angew. Chem., Int. Ed. 2001, 40, 2004-2021.
11. Wu, P.; Feldman, A. K.; Nugent, A. K.; Hawker, C. J.; Scheel, A.; Voit, B.; Pyun, J.; Frèchet, J. M. J.; Sharpless, K. B.; Fokin, V. V. Angew. Chem., Int. Ed. 2004, 43, 3928-3932.
12. Gupta, N.; Vestberg, R.; Malkoch, M.; Hikita, S. T.; Thibault, R. J.; Lingwood, M; McCarney, E.; Han, S.; Clegg, O. D.; Hawker, C. J. Polym. Prepr. 2006, 47, 25-26.
13. Laine, J.; Lindstrom, T.; Nordmark, G. G.; Risinger, G., Studies on topochemical modification of cellulosic fibers. Part 1. Chemical conditions for the attachment of carboxymethyl cellulose onto fibers. Nordic Pulp & Paper Research Journal. 2000, 15, (5), 520.
14. Kontturi, E.; Thune, P. C; Niemantsverdriet, J. W., Cellulose Model Surfaces Simplified Preparation by Spin Coating and Characterization by X-ray Photoelectron Spectroscopy, Infrared Spectroscopy, and Atomic Force Microscopy. Langmuir 2003, 19, (14), 5735.
15. Schaub, M.; Wenz, G.; Wegner, G.; Stein, A.; Klemm, D., Ultrathin films of cellulose on silicon wafers. Advanced Materials 1993, 5, (12), 919.
16. Rodahl, M.; Hook, F.; Krozer, A.; Brzezinski, P.; Kasemo, B., Quartz crystal microbalance setup for frequency and Q-factor measurements in gaseous and liquid environments. Section Title: Electric Phenomena 1995, 66, (7), 3924.
17. Höök, F.; Rodahl, M.; Brzezinski, P.; Kasemo, B., Energy dissipation kinetics for protein and antibody-antigen adsorption under shear oscillation on a quartz crystal microbalance. Langmuir 1998, 14, (4), 729.
18. J. Justynska, Z. Hordyjewicz, H. Schlaad, Toward a toolbox of functional block copolymers via free-radical addition of mercaptans, Polymer, 2005, 46, 12057-12064.
19. Killops, K. L.; Campos, L. M.; Hawker, C. J., J. Am. Chem. Soc, 2008, 130, 62.
20. Rosen, B. R.; Lligadas, G.; Hahn, C; Percec, V., J. Polym. Sci., Part A; Polym. Chem., 2009, 47,3931.

1. A method of modifying the surface of a cellulosic material, wherein a modifying compound is attached to the cellulosic material through a linker, characterized by the linker being a conjugate selected from carboxymethyl cellulose (CMC), or a polymer, selected from glucomannan, xyloglucane, chitosan and different gums, which conjugate has been activated by functionalization prior to adsorption of the linker to the cellulosic material or to the modifying compound to form an activated conjugate, and by the entire method being carried out in aqueous media.

2. The method of claim 1, wherein the activated conjugate is first adsorbed to the cellulosic material, and thereafter covalently attached to the modifying compound.

3. The method of claim 1, wherein the activated conjugate is first covalently attached to the modifying compound, and thereafter adsorbed to the cellulosic material.

4. The method of claim 1, wherein, the cellulosic material is selected from cellulose fibres, lines, nano or micro cellulose fibrils, macrocrystalline cellulose, nanocrystalline cellulose (nanowhisker) or some other cellulose based material, including textile materials as well as paper and board grades, such as filter papers.

5. (canceled)

6. The method of claim 1, wherein the activating functionalization reaction is selected from reactions that provide the conjugate with a functionality selected from azide, triple bond, double bond, thiol, and halogen.

7. The method of claim 1, wherein the modifying compound is selected from biomolecules, such as DNA, RNA, albumin, including bovine serum, albumin (BSA), biotin, hemoglobin, other proteins, polymers, oligomers, dyes, including luminescent dyes, radiolabels, and nanoparticles, or mixtures or complexes thereof.

8. The method of claim 1, wherein the modifying compound is functionalized prior to adsorption using a reaction selected from reactions that provide the compound with a functionality selected from azide, triple bond, double bond, thiol, and halogen.

9. The method of claim 6, wherein the conjugate and the modifying compound are subjected to different functionalization reactions, thereby providing one of these components with an azide, a thiol or a halogen functionality and the other component with a triple bond or a double bond functionality.

10. The method of claim 1, wherein the adsorption of the linker to the surface of the cellulosic material takes place through multiple interactions, mainly through the hydroxyl, carbonyl, amine or sulphate groups present on the surfaces of both the linker and the cellulosic material.

11. An intermediate product suitable for adsorbing to a modifying compound selected from biomolecules, such as DNA, RNA, albumin, including bovine serum albumin (BSA), biotin, hemoglobin, other proteins, polymers, oligomers, dyes, including luminescent dyes, radiolabels, and nanoparticles, or mixtures or complexes thereof, characterized in that the intermediate product comprises a functionalized conjugate linker selected from carboxymethyl cellulose (CMC) or a polymer selected from glucomannan, xyloglucane, chitosan and different gums, which linker has been adsorbed to a cellulosic material.

12. The intermediate product of claim 11, wherein the intermediate product consists of a functionalized conjugate linker that has been adsorbed to a cellulosic material.

13. The intermediate product of claim 11, wherein the cellulosic material is selected from cellulose fibres, fines, nano or micro cellulose fibrils, microcrystalline cellulose, nanocrystalline cellulose (nanowhisker) or some other cellulose based material, including textile materials as well as paper and board grades, such as filter papers.

14. The intermediate product of claim 11, wherein the conjugate is carboxymethyl cellulose (CMC).

15. The intermediate product of claim 11, wherein the functionalized conjugate linker contains an azide, a thiol, a halogen, a triple bond or a double bond functionality.

16. Use of a conjugate linker selected from carboxymethyl cellulose (CMC) or a polymer selected from glucomannan, xyloglucane, chitosan and different gums, which linker has been activated by functionalization, in adsorbing a modifying compound to a cellulosic material, wherein the modifying compound is selected from biomolecules, such as DNA, RNA, albumin, including bovine serum albumin (BSA), biotin, hemoglobin, other proteins, polymers, oligomers, dyes, including luminescent dyes, radiolabels, and nanoparticles, or mixtures or complexes thereof, whereby the conjugate is adsorbed to the cellulosic material using physical interactions, and the modifying compound is adsorbed to the cellulosic material via the conjugate.

17. Use of a conjugate linker selected from a Carboxymethyl cellulose (CMC) or a polymer selected from glucomannan, xyloglucane, chitosan and different gums, which linker has been activated by functionalization, in preparing a cellulose-based product having a surface that has been modified by the adsorption of one or more layers of a modifying compound to a cellulosic material via said linker, the product being selected from biointerfaces, bioactive paper and textile products, electroactive and electrically conducting compositions, hydrophobic and superhydrophobic materials, optically active materials, porous materials, and materials and intermediate products for high strength composite materials, particularly thermo/stimuli responsive materials, branched materials, dendritic materials, graphene, SWCNT, MWCNT, nanoclay, fluorescent materials, and supramolecular materials.

18. Use of a conjugate linker selected from carboxymethyl cellulose (CMC) or a polymer selected from glucomannan, xyloglucane, chitosan and different gums, which has been activated by functionalization, in adsorbing a modifying compound to a cellulosic material, wherein the modifying compound is selected from biomolecules, such as DNA, RNA, albumin, including bovine serum albumin (BSA), biotin, hemoglobin, other proteins, polymers, oligomers, dyes, including, luminescent dyes, radiolabels, and nanoparticles, or mixtures or complexes thereof, whereby the modifying compound is first adsorbed to a conjugate, whereafter the thus formed modified conjugate is adsorbed to the cellulosic material.

19. The use according to claim 16, wherein more than one different type of conjugate is adsorbed to the cellulosic surface, thus providing multifunctionalization.

20. The use according to claim 16, wherein more than one layer of modifying compounds are adsorbed to the cellulosic material, the further layers being adsorbed mainly via physical interactions, or alternatively a covalent activation of the modifying compound of the primary layer is used to attach the farther layers covalently.
